(19) United States
(12) Patent Application Publication
(10) Pub. No.: US 2017/0295763 A1
(43) Pub. Date: Oct. 19, 2017

(54) Harvesting Brine Shrimp Eggs

(71) Applicant: Ocean Star International, Inc., Snowville, UT (US)

(72) Inventors: Simon S. Goe, Snowville, UT (US); Jose Castro, Snowville, UT (US)

(73) Assignee: Ocean Star International, Inc., Snowville, UT (US)

(21) Appl. No.: 15/133,141

(22) Filed: Apr. 19, 2016

(51) Int. Cl. A01K 79/00; A01K 74/00; A01K 75/04; A01K 71/00

(52) U.S. Cl. CPC A01K 79/00; A01K 71/00; A01K 74/00; A01K 75/04

(57) ABSTRACT

A curtain of a boom for harvesting brine shrimp eggs includes mesh sections for directing a flow of water in a first direction such that an amount of the brine shrimp eggs swept under the curtain of the boom during a harvesting process is minimized and a bottom section located below the mesh sections for directing a flow of water in a second direction during the harvesting process such that debris in the water is swept under the curtain of the boom.

### BACKGROUND

Brine shrimp (Artemia species) are a type of aquatic crustacean. Brine shrimp have several life stages including a cyst stage, multiple naupliar stages, larval stages, juvenile stages, and an adult stage. In the cyst stage, the cysts (hereafter brine shrimp eggs) are typically 200 to 300 microns in size. However, brine shrimp eggs can be smaller in size. In the adult stage, the body of the brine shrimp can grow to 10 to 20 millimeters in length. The body of the brine shrimp includes a head, thorax, and abdomen. The entire body of the brine shrimp is covered in a thin exoskeleton.

Brine shrimp are found worldwide in bodies of water that are high in salinity (hypersaline bodies of water), including lakes and ponds. For brine shrimp to flourish, these bodies of water must contain levels of salinity ranging between twenty-five percent and two-hundred fifty percent.

### BRIEF DESCRIPTION OF THE DRAWINGS

The accompanying drawings illustrate various examples of the principles described herein and are a part of the specification. The examples do not limit the scope of the claims.

FIG. 1 is an isometric view of a boom for harvesting brine shrimp eggs, according to one example of principles described herein.

FIG. 2 is an isometric view of a section of the boom, according to one example of principles described herein.

FIG. 3 is a side view of the boom, according to one example of principles described herein.

FIG. 4 is a side view of the boom during a harvesting process, according to one example of principles described herein.

FIG. 5 is a flowchart of a method for harvesting brine shrimp eggs, according to one example of principles described herein.

Throughout the drawings, identical reference numbers designate similar, but not necessarily identical, elements.

### DETAILED DESCRIPTION

As mentioned above, brine shrimp are a type of aquatic crustacean that are found worldwide in bodies of water that are high in salinity. Brine shrimp can reproduce every few days by giving live birth or by producing dormant eggs known as cysts or brine shrimp eggs.

Brine shrimp eggs are usually found floating with debris at or near the surface of the body of water. The debris can include, for example, live and dead brine shrimp, discarded brine shrimp shell casings, organic matter such as pieces of wood, tumble weeds, twigs, inorganic material such as trash, and/or other types of debris. Sometimes, the brine shrimp eggs are blown by wind or carried by the water currents to the surrounding shoreline of the body of water.

Brine shrimp eggs are commercially harvested as feedstock. For example, nauplii hatched from the harvested brine shrimp eggs are used in aquaculture to feed baby shrimp and baby fish grown commercially for human consumption.

To harvest the brine shrimp eggs, the harvesting process generally includes collecting the brine shrimp eggs from the body of water via a boom, cleaning the brine shrimp eggs, drying the brine shrimp eggs, and packaging the brine shrimp eggs for storage. Once harvested, the brine shrimp eggs may be packaged, stored for long periods, and hatched on demand to provide a convenient form of live feed for larval fish and/or crustaceans grown for human consumption. Because brine shrimp eggs have the capability of being stored for several years as a packaged commodity, brine shrimp eggs have also become a desired food source for feeding fish and/or other small aquatic animals in salt water and/or freshwater aquariums.

Often, the brine shrimp eggs are harvested from a body of water using a boom. The boom is placed in the water next to the brine shrimp eggs and then pulled through the water to collect the brine shrimp eggs. Alternatively, the wind and/or the water currents move the brine shrimp eggs into the boom.

Such a boom could include a number of floats and a solid, non-porous curtain hanging from each of the floats. The non-porous curtain would not allow water to flow through the boom, but requires water to pass downward and under the curtain. However, using a boom with a non-porous curtain results in some of the brine shrimp eggs being swept under the boom with the flow of water during the harvesting process, especially when freshwater is floating on top of the salt water in the body of water where harvesting is occurring. As a result, the amount of brine shrimp eggs harvested is reduced.

Alternatively, a boom with a number of floats and a porous curtain hanging down from each of the floats could be used. The porous curtain would allow water to flow through. Because the porous curtain allows water to flow through the boom, the brine shrimp eggs are less likely to be swept under to boom. However, this type of boom collects large amounts of unwanted debris and is not durable. As a result, the brine shrimp eggs and the large amounts of debris have to be manually separated in a post-harvesting cleaning process. This can add a significant amount of time and labor costs to harvesting.

Consequently, the principles described herein include a curtain of a boom for harvesting brine shrimp eggs. Such a curtain includes a number of mesh sections for directing a flow of water in a first direction such that an amount of the brine shrimp eggs swept under the curtain of the boom during a harvesting process is minimized and a bottom section located below the mesh sections for directing a flow of water in a second direction during the harvesting process such that debris in the water is swept under the curtain of the boom. The mesh section allows the water to flow through a portion of the curtain and not disrupt the collection of brine shrimp eggs that float at or near the surface of the water as they are driven into the boom via the wind, water currents or while the boom is pulled by, for example, boats during the harvesting process. Such a curtain maximizes the amount of brine shrimp eggs collected while minimizing the amount of debris collected during the harvesting process. As a result, labor cost and time with respect to removing debris from the boom for the post-harvesting cleaning process is minimized while the amount of brine shrimp eggs collected is maximized.

In the present specification and in the appended claims, the term “harvesting process” means a series of steps or procedures that are utilized to collect brine shrimp eggs from a body of water. The harvesting process includes utilizing a boom to collect the brine shrimp eggs.

In the present specification and in the appended claims, the term “mesh sections” means portions of a curtain of a boom that is made out of a porous material. The mesh sections allow water, but not brine shrimp eggs to flow through the boom such that an amount of the brine shrimp eggs swept under the curtain of a boom during a harvesting process is minimized. The mesh sections direct water to flow in a first direction during a harvesting process.

In the present specification and in the appended claims, the term “bottom section” means a portion of a curtain made out of a non-porous material. The bottom section allows debris in the water to be swept under the curtain of the boom. The bottom section directs water to flow in a second direction during a harvesting process.

In the present specification and in the appended claims, the term “stiffening rods” means a mechanism used to provide rigidity to a boom. The stiffening rods maintain an upper section of a boom parallel to a curtain of the boom during a harvesting process. The stiffening rods may also extend partially into a lower portion of the boom such as the bottom section.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

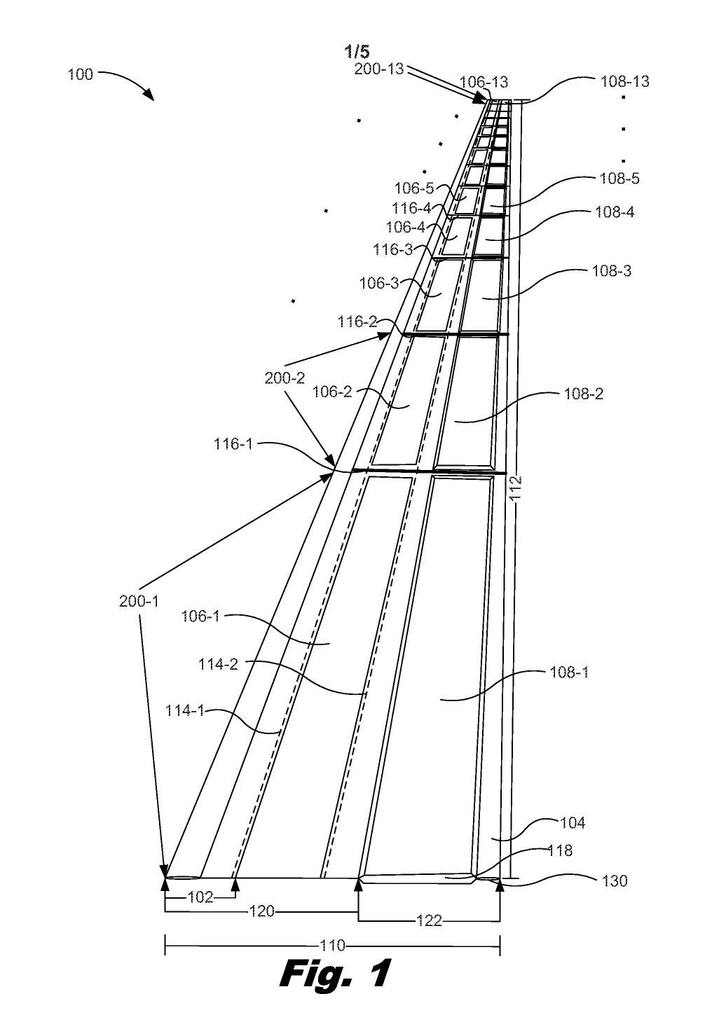

Referring now to the figures, FIG. 1 is an isometric view of a boom for harvesting brine shrimp eggs, according to one example of principles described herein. The boom includes a number of floats and a curtain hanging down from each of the floats. The curtain includes a number of mesh sections and a bottom section.

As mentioned above, a boom (100) is used to harvest brine shrimp eggs from a body of water. The harvesting process includes a series of steps or procedures that are utilized to collect brine shrimp eggs from the water. For example, to harvest the brine shrimp eggs, the boom (100) is placed in the water next to the brine shrimp eggs. A top surface of the boom floats at the surface of the water, while the curtain hangs vertically and submerged in the water below the top of the boom. The boom (100) is then pulled through the water to collect the brine shrimp eggs or the wind and/or the water currents move the brine shrimp eggs into the boom (100). More information about harvesting the brine shrimp eggs with the boom (100) is described below.

Often, the boom (100) is subject to extreme wear and tear before, during, and after a harvesting process. The wear and tear includes, but not limited to loading and offloading the boom (100) from a boat, pulling the boom (100) in the body of water, the boom (100) making contact with rocks, debris and/or the bottom of the body of water.

For the life of the boom (100) to be maximized, at least some of the portions of the boom (100) are made out of a durable material. The durable material may be, for example, a polyvinyl chloride material. In some examples, the polyvinyl chloride may be modified to contain a plasticizer. In another example, the durable material is a polyurethane material, nylon material, a plastic material, a polyester material, other durable materials, or combinations thereof. Further, the entire boom (100), except the mesh sections (106), may be made from any or combinations of these durable materials. In some examples, portions of the boom (100) where the boom (100) is likely to be repeatable subjected to wear and tear can be reinforced with, for example, an extra layer of the durable material. In other examples, these portions of the boom (100) may be constructed with a durable material that is thicker than other portions of the boom (100).

In an example, the boom (100) is defined by a length (112) and a width (110). Typically, the length (112) of the boom (100) is greater than the width (110) of the boom (100). As indicated above, the boom is oriented in the water such that the length of the boom is parallel to the surface of the water and the width of the boom extends downward into the water.

For harvesting brine shrimp eggs, in one particular example, the length (112) of the boom (100) is between fifty and one-hundred feet. The width (110) of the boom (100) is between twenty-four and thirty-two inches. Further, the width (110) and the length (112) of the boom (100) can vary depending on a number of factors. The factors include the intended purpose of the boom (100), an amount of brine shrimp eggs desired to be harvested at a single time, the boat or other equipment used with the boom, local harvesting conditions in the water, other factors, or combinations thereof. As a result, the length (112) of the boom (100) may be greater than one-hundred feet or less than fifty feet. Further, the width (110) of the boom (100) may be greater than thirty-two inches or less than twenty-four inches.

The boom (100) includes a number of sections (200). As illustrated, the boom (100) includes thirteen sections (200). For example, the boom (100) includes a first section (200-1), a second section (200-2), a third section (200-3), a fourth section (200-4), a fifth section (200-5), a sixth section (200-6), a seventh section (200-7), an eighth section (200-8), a ninth section (200-9), a tenth section (200-10), an eleventh section (200-11), a twelfth section (200-12) and a thirteenth section (200-13).

As will be described below, each of the sections (200) includes an upper section (122). The upper section (122) includes a portion of a cable sleeve (104) and a float (108). Each of the sections (200) includes a curtain (120). The curtain (120) includes a number of mesh sections (106) and a portion of a bottom section (102). For example, the first section (200-1) includes a portion of the cable sleeve (104), a first float (108-1), a first mesh section (106-1) and a portion of the bottom section (102). The second section (200-2) includes a portion of the cable sleeve (104), a second float (108-2), a second mesh section (106-2) and a portion of the bottom section (102). The third section (200-3) includes a portion of the cable sleeve (104), a third float (108-3), a third mesh section (106-3) and a portion of the bottom section (102). The fourth section (200-4) includes a portion of the cable sleeve (104), a fourth float (108-4), a fourth mesh section (106-4) and a portion of the bottom section (102). The fifth section (200-5) includes a portion of the cable sleeve (104), a fifth float (108-5), a fifth mesh section (106-5) and a portion of the bottom section (102). The sixth section (200-6) includes a portion of the cable sleeve (104), a sixth float (108-6), a sixth mesh section (106-6) and a portion of the bottom section (102). The seventh section (200-7) includes a portion of the cable sleeve (104), a seventh float (108-7), a seventh mesh section (106-7) and a portion of the bottom section (102). The eighth section (200-8) includes a portion of the cable sleeve (104), an eighth float (108-8), an eighth mesh section (106-8) and a portion of the bottom section (102). The ninth section (200-9) includes a portion of the cable sleeve (104), a ninth float (108-9), a ninth mesh section (106-9) and a portion of the bottom section (102). The tenth section (200-10) includes a portion of the cable sleeve (104), a tenth float (108-10), a tenth mesh section (106-10) and a portion of the bottom section (102). The eleventh section (200-11) includes a portion of the cable sleeve (104), an eleventh float (108-11), an eleventh mesh section (106-11) and a portion of the bottom section (102). The twelfth section (200-12) includes a portion of the cable sleeve (104), a twelfth float (108-12), a twelfth mesh section (106-12) and a portion of the bottom section (102). The thirteenth section (200-13) includes a portion of the cable sleeve (104), a thirteenth float (108-13), a thirteenth mesh section (106-13) and a portion of the bottom section (102).

As mentioned above, each of the sections (200) includes an upper section (122). In an example, the upper section (122) includes a cable sleeve (104). The cable sleeve (104) is used to accommodate a cable (424). The cable (424) is used to direct the boom (100) through water during a harvesting process. The cable sleeve (104) is made out of the durable material described above and includes an opening (130) to house a cable (424) as illustrated in FIG. 1. In this example, the cable (424) runs the entire length (112) of the boom (100). In some examples, the cable (424) connects to ends. The ends are made out of corrosion resistant material such as aluminum or stainless steel. The ends are connected to, for example, a boat such that the boat can pull the boom (100) through the water during the harvesting process via the cable (424). The ends of the boom (100) can also be attached to another boom to increase the overall length of the boom. For example, the ends of two one-hundred foot booms can be connected such that a single two-hundred foot boom is created.

As mentioned above, the upper section (122) includes a number of floats (108). The floats (108) provide buoyancy to the boom (100) when portions of the boom (100) are submerged in the water during the harvesting process. Sufficiently buoyant material (118) is used to provide a means for sustaining a portion of the boom (100) from sinking, especially in relation to the disposition of the weights in the bottom section (102) of the curtain (120). Any suitable buoyant material and/or variations in the structural design of the boom (100) could be used to provide buoyancy to the boom (100). Buoyant materials include, but are not limited to synthetic resinous materials, for example, polypropylene or polystyrene and/or a closed cell polypropylene foam. In some example, the buoyant material (118) is housed within a solid covering (i.e. the durable material) of the boom (100) that supports structural integrity and retains the dimensional shape of the floats (108).

Depending on the buoyant material of the floats (108), the floats (108) provide rigidity to the sections (200) of the boom (100). For example, the first float (108-1) provides rigidity to the first section (200-1) of the boom (100). This allows the boom (100) to maintain its basic structural shape during the harvesting process. In other words, the boom (100) can flex between each of the sections (200); however, this flexing is minimized for each of the sections (200).

As described above, each of the sections (200) includes a curtain (120). The curtain (120) is made of any of the materials described in this specification and has a dimensional width sufficient for being disposed below the surface of the water. Portions of the curtain (120) are made out of a flexible material such as nylon. As will be described below, portions of the curtain (120) are made from a porous material or a non-porous material such that the amount of brine shrimp eggs collected is maximized during the harvesting process while the amount of debris collected during the harvesting process is minimized.

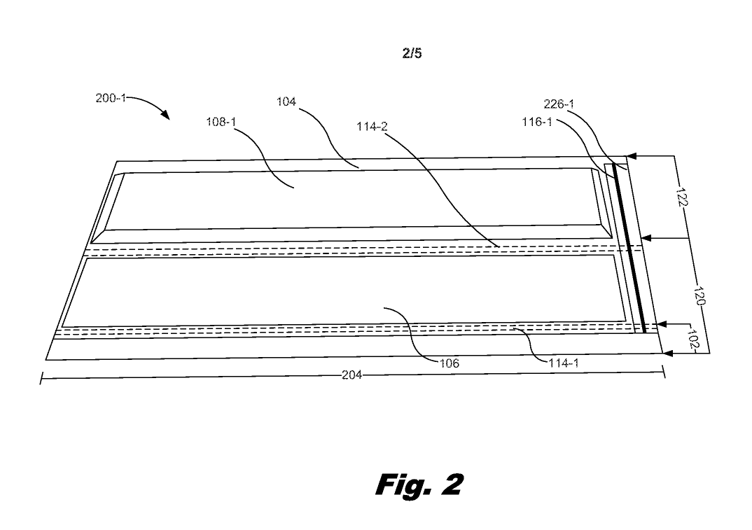

Further, a number of openings are defined in the curtain (120). The openings are sized to accommodate a number of mesh sections (106). As will be described below, once the openings are created, the mesh sections (106) are placed over the openings in the curtain (120) and attached to the curtain (120) via a number of methods. These methods include sewing, gluing, or other methods. As illustrated, the mesh sections (106) are attached to the curtain (120) via sewing. In an example, a first stitch line (114-1) attaches a portion of the mesh sections (106) to a portion of the curtain (120). A second stitch line (114-2) attaches another portion of the mesh sections (106) to another portion of the curtain (120). In FIG. 1 the stitch lines (114) are a single stitch line. In FIG. 2 the stitch lines (114) are a double stitch line. In some examples, the more securely the mesh sections (106) are attached to the curtain (120), the more durable this portion of the curtain (120) is. As a result, a double stitch line may be preferable over a single stitch line.

The mesh sections (106) are portions of the curtain (120) of the boom (100) that are made out of a porous material. Any suitable material can be employed to create the mesh sections (106). For example, a polymeric material, such as nylon or polyester can be used to. The openings defined in the mesh sections (106) are sized to allow the water, but not the brine shrimp eggs to flow through the mesh sections (106). For example, the mesh sections (106) are made of a porous material that is at least one-hundred twenty mesh. In some examples, the larger the mesh size, the smaller the opening of the mesh sections (106). A mesh section that is at least one-hundred twenty mesh is sized such that a typical size of a brine shrimp egg cannot pass through the mesh sections (106). In some examples, brine shrimp egg can vary in size. As a result, the mesh size of the mesh sections (106) could be greater than or less than one-hundred twenty mesh.

Although mesh sizes less than one-hundred twenty mesh could be used, in the case of brine shrimp eggs, some brine shrimp eggs will begin to pass through the mesh sections (106). As a result, some of the brine shrimp eggs will be lost.

Although mesh sizes greater than the one-hundred twenty mesh could be used, such mesh sizes present greater drag resistance as the curtain (120) is moved through the water. If the drag resistance is too great, the boom (100) could be more difficult or costly to operate. Further, if the boom (100) is moved too quickly through the water during the harvesting process, the water will not flow in as desired as easily (i.e. through the mesh sections (106)). This could result in some of the brine shrimp eggs being swept underneath the boom (100) and lost.

Thus, an ideal mesh size is one that will capture the maximum amount of brine shrimp eggs with the minimal amount of drag resistance. As a result, depending on the size of the brine shrimp egg, it may be preferable that the mesh sections (106) to be made of a porous material that is greater or less than one-hundred twenty mesh.

As mentioned above, the mesh sections (106) allow the water to flow out of the boom (100). This allows the brine shrimp eggs to collect more easily in the boom (100). In some examples, the dimensions of the mesh sections (106) (i.e. width and length) are based on a speed of the water. For example, if the water is flowing fast, the boom needs to allow more water to flow through the mesh sections (106) to maximize brine shrimp egg collection. If the water is flowing slowly, the boom needs to allow less water to flow through the mesh sections (106) to maximize brine shrimp egg collection. As a result, the width of the mesh sections (106) is greater for faster flowing water than slower moving water.

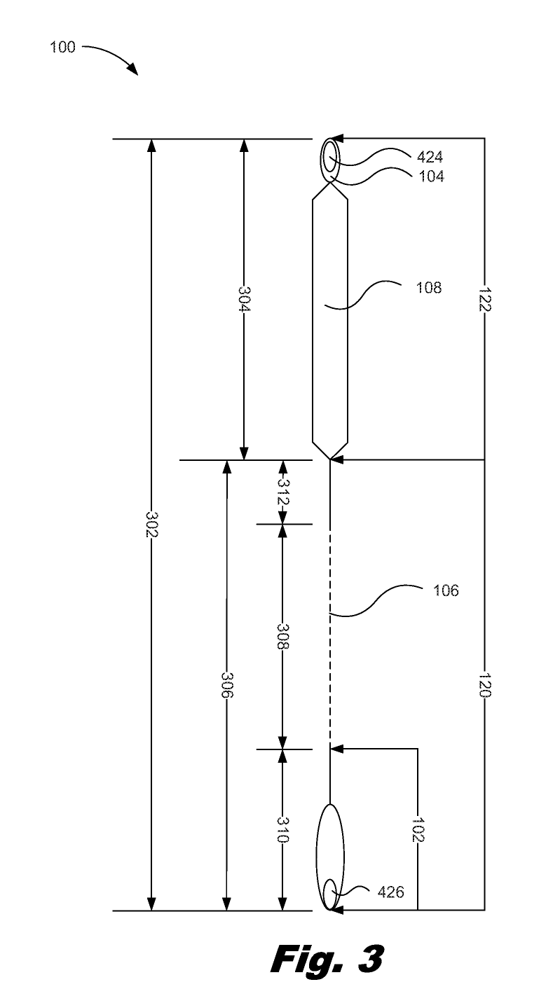

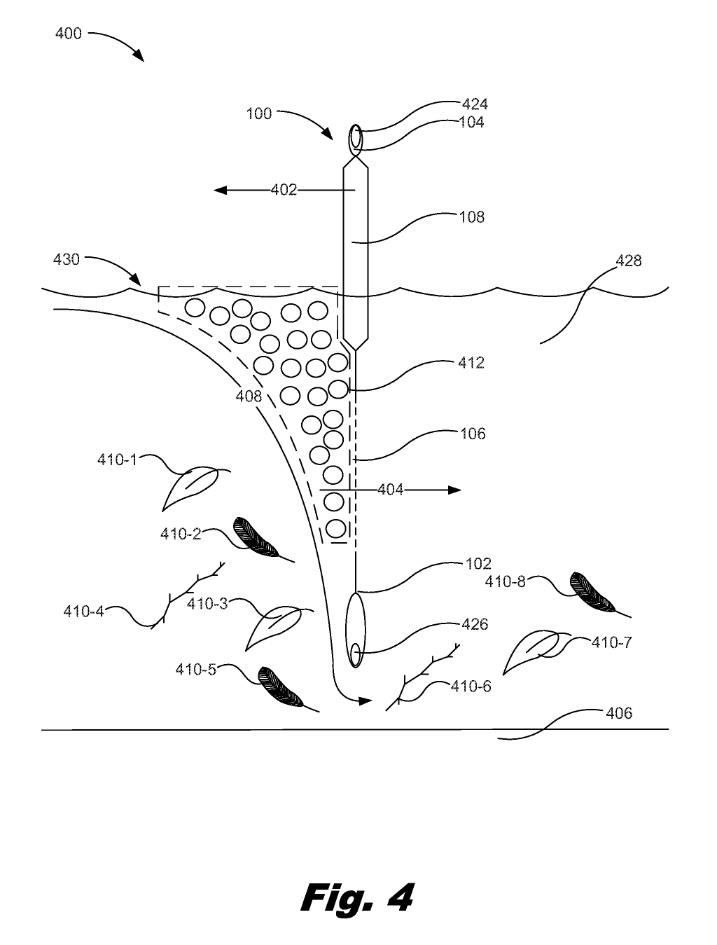

As will be described in FIG. 3, the width of each of the mesh sections (106) in the illustrated example is seven inches. As a result, the mesh section (106) allows water, but not brine shrimp eggs to flow through the curtain (120) such that an amount of the brine shrimp eggs swept under the curtain (120) of a boom (100) during a harvesting process is minimized. As will be described in FIG. 4, the mesh section (106) directs water to flow in a first direction during a harvesting process, i.e., through the mess. As a result, the amount of the brine shrimp eggs swept under the curtain (120) of the boom (100) during the harvesting process is minimized.

The curtain (120) includes a bottom section (102). The bottom section (102) is located below the mesh sections (106) and hangs below the mesh sections (106) underwater when the boom is in operation. The bottom section (102) is a portion of the curtain (120) made out of a non-porous material. The bottom section (102) allows debris in the water to be swept under the curtain (120) of the boom (100). As will be described in FIG. 4, the bottom section (102) directs water to flow in a second direction during the harvesting process, i.e., under the boom. As a result, the bottom section (102) directs the flow of the water in the second direction during the harvesting process such that debris in the water is swept under the curtain (120) of the boom (100).

Often, the bottom section (102) of the boom (100) is subjected to the most wear and tear especially when the bottom section (102) makes contact with rocks, debris and/or the bottom of a body of water. For the life of the bottom section (102) of the boom (100) to be maximized, the bottom section (102) is made out of a durable material, as described above.

Further, the bottom section (102) accommodates a weight (426) to retain the curtain (120) of the boom (100) below the surface of the water. In some examples, the weight (426) is a semi-flexible material such as a chain or a cable. The weight (426) is sufficiently disposed in relation to the float to provide a weighted means for retaining the curtain (120) below the surface of the water. A chain may be preferable over a cable since the chain flexes more easily when the boom (100) is utilized in a harvesting process.

The boom (100) further includes stiffening rods (116). The stiffening rods (116) are a mechanism used to provide rigidity to the boom (100). The stiffening rods (116) are made out of semi-flexible material such as fiberglass. The stiffening rods (116) can be round in shape, square in shape, rectangular in shape, or another shape.

The stiffening rods (116) prevent the curtain (120) of the boom (100) from flowing in an opposite direction that the boom (100) is being pulled in. As a result, the stiffening rods (116) maintain the upper section (122) of the boom (100) parallel to the curtain (120) of the boom (100) during the harvesting process.

FIG. 2 is an isometric view of a section of a boom, according to one example of principles described herein. As will be described above, the boom includes a number of sections. Each of the sections includes a portion of the cable sleeve, a float, a mesh section, and a portion of the bottom section.

While FIG. 2 illustrates and describes a first section (200-1) of the boom (100). It should be understood that the other sections (200) of the boom (100) are similar to the first section (200-1). As a result, FIG. 2 is an example of a section of the boom (100).

The first section (200-1) is defined by a length (204). In some examples, the length (204) of the first section (200-1) is five feet. The length (204) of the first section (200-1) can vary depending on a number of factors. The factors include the intended purpose of the boom (100), an amount of brine shrimp eggs that is desired to be harvested at a single time, other factors, or combinations thereof. As a result, the length (204) of the first section (200-1) can be greater or less than five feet.

As illustrated, the first section (200-1) of the boom (100) includes a first float (108-1). The first float (108-1) is buoyant in nature to allow at least a portion of the boom (100) to float above the surface of the water during the harvesting process. The shape of the first float (108-1) is based on a number of factors. The factors include the intended purpose of the boom (100), an amount of brine shrimp eggs desired to be harvested at a single time, other factors, or combinations thereof. While the first float (108-1) in FIG. 2 is illustrated as rectangular in shape, the first float (108-1) could be another shape. For example, the first float (108-1) could be a square shape, a round shape, a triangular shape, or another shape.

Further, the first section (200-1) includes a curtain (120). The curtain (120) includes a first mesh section (106-1). As will be described below, the top of the first mesh section (106-1) is submerged just below the surface of the water during the harvesting process. The first mesh section (106-1) collects the brine shrimp eggs at the top of the curtain (120).

The curtain (120) further includes a bottom section (102). The bottom section (102) is made of a non-porous material. The bottom section (102) stiffens the curtain (120) and is durable. The stiffening is important because as the boom (100) is being pulled or closed, the curtain (120) tends to flow backward and outward allowing the captured brine shrimp eggs to flow under the curtain (120) if the curtain (120) is not properly maintained in a vertical position. In some examples, the more vertical the curtain (120) is kept the better. As a result, the bottom section (102) of the curtain stiffens the curtain (120) such that the curtain (120) is maintained in a vertical position.

In some examples, the bottom section (102) of the curtain (120) is made of a nylon material, a vinyl material, or a plastic material. This allows the boom (120) to be more durable, for example, when contacting rocks, sand, debris, parts of a boat, or a shoreline. The bottom section (102) allows the debris to slides under the curtain (120) of the boom (100).

In contrast, without the bottom section (102) (i.e. the curtain (120) being made entirely of a porous material), debris collects on the curtain (120) and just stays in the boom along with the brine shrimp eggs. This is because a curtain being made entirely of a porous material tends to sieve both the brine shrimp eggs and debris from the water.

As a result, there are at least three benefits for a boom (100) with a mesh section (106) that is porous and a bottom section (102) that is non-porous. 1) This allows the boom (100) to flow better through the water. 2) This maximizes an amount of brine shrimp eggs collected during the harvesting process. 3) This minimizes the amount of debris collected during the harvesting process.

As mentioned above, the boom (100) includes stiffening rods (116). Each of the stiffening rods (116) are inserted into corresponding pockets (226) located between each section (200) of the boom (100). The pockets (226) of the boom (100) are made out of a durable material described above. In some examples, the pockets (226) of the boom (100) are attached to the boom (100) via sewing, gluing, or combinations thereof.

The pockets (226) of the boom (100) can extend between the bottom of the cable sleeve (104) and the top of the bottom section (102). In other examples, the pockets (226) of the boom (100) can extend from one or two inches below the top of the boom (100) and one or two inches above the bottom of the boom (100). In these examples, the stiffening rods (116) are the same length as the pockets (226). In some examples, the longer the stiffening rods (116), the more rigidity provided to the boom (100).

Turning specifically to FIG. 2, a first stiffening rod (116-1) is inserted into a first pocket (226-1) of the boom (100) between the first section (200-1) of the boom (100) and a second section (200-2) of the boom (100).

FIG. 3 is a side view of a boom, according to one example of principles described herein. As will be described below, the parts of the boom are specific dimensions to allow the boom to maximize the amount of brine shrimp eggs collected during the harvesting process and minimize the amount of debris collected during the harvesting process. FIG. 3 illustrates the orientation of the boom in the water during use.

From the top of the boom (100) with the cable sleeve (104) to the bottom of the bottom section (102), the width of each of the sections (200) is thirty-two inches as indicated by arrow 302. In other examples, the top of the boom (100) with the cable sleeve (104) to the bottom of the bottom section (102), the width of each of the sections (200) is twenty-four inches. In an example, a wider boom is preferable when harvesting large amounts of brine shrimp eggs in deep bodies of water. In contrast, a narrower boom is preferable when harvesting small amounts of brine shrimp eggs in shallow bodies of water. As a result, the width of the boom (100) can be more or less than thirty-two inches.

The width of the upper section (122) is eight inches as indicated by arrow 304. Because the floats (108) provide the boom (100) with buoyancy, a wider upper section (122) is suggested when using a wider curtain. In contrast, a narrower upper section (122) is suggested when using a narrower curtain. As a result, the upper section (122) can be more or less than eight inches.

In some examples, the curtain (120) is sixteen inches in width as indicated by arrow 306. However, the width of the curtain (120) could be between twenty-four and thirty-two inches in width depending on the intended purpose of the boom (100).

From the floats (108) to the start of the mesh sections (106) is two inches in width as indicated by arrow 312. In some examples, this is to accommodate the stitching needed to attach the mesh sections (106) to the curtain (120). With other manufacturing techniques, the mesh sections (106) are attached directly to the floats (108). As a result, the width between the floats (108) to the start of the mesh sections (106) can be as little as zero inches.

The width of the mesh sections (106) are nine inches. However, due to the overlap of the mesh sections (106) and the openings defined in the curtain (120), the mesh sections (106) are seven inches in width as indicated by arrow 308. In some instances, the width of the mesh section (106) depends on an amount of brine shrimp eggs the user of the boom (100) intends to harvest at a time. For example, if the user intends to harvest three tons of brine shrimp eggs at a time, the mesh sections (106) for the boom (100) should be seven inches in width or more. If the user intends to harvest less than one ton of brine shrimp eggs at a time, the mesh sections (106) for the boom (100) could be less than seven inches in width. As a result, the more brine shrimp eggs the user intends to harvest, the wider in width the mesh sections (106) should be. In an example, the lengths of the mesh sections (106) are fifty-six inches.

From the bottom of the mesh sections (106) to the bottom of the bottom section (102) is five inches as indicated by arrow 310. This measurement may increase or decrease depending on the desired results. Again, this is to provide stiffness to the boom (100) and to direct the flow of water in a second direction, under the boom, as described in FIG. 4.

FIG. 4 is a side view of a boom during a harvesting process, according to one example of principles described herein. When the brine shrimp eggs are collected in an open body of water, the boom is placed perpendicular to the flowing concentration of brine shrimp eggs in a semi-circular fashion. The boom is held steady and the floating brine shrimp eggs then flow into the boom or the boom is dragged around in the water to allow the brine shrimp eggs to collect against to boom. In both cases, the water corralled with the brine shrimp eggs must escape under the boom.

As indicated, sometimes the brine shrimp eggs are poorly floating and they get swept under the boom with debris. Sometimes freshwater floats on top of the salt water and the submerged brine shrimp eggs then tend to flow under the boom. The mesh sections (106) allow a second avenue for the water to escape without the brine shrimp eggs being swept under the boom.

As will be described below, the brine shrimp eggs (412) are collected on the mesh section (106) of the boom (100). Once the brine shrimp eggs (412) are corralled, the boom (100) is tightened into a small section and the concentrated eggs are pumped onto a boat.

When harvesting on the shore, the boom (100) is used in a similar manner as described above. One end of the boom (100) is set on the shore and the other is extended out into the water at an angle into the flow of the brine shrimp eggs. Typically, the angle is less than 90 degrees relative to the shore. Usually the boom (100) is not perfectly straight but has a slight curve to it. The flow of the brine shrimp eggs coming into the shore or along the shore is funneled into the boom (100). Once corralled, the brine shrimp eggs are pumped into bags.

Turning specifically to FIG. 4, when brine shrimp eggs (412) are concentrated in a boom (100), due to the buoyant nature of the brine shrimp eggs (412), the brine shrimp eggs (412) float on or near the surface (430) of the water (428). The mesh sections (106) allow a flow of the water (428) to be directed in a first direction as indicated by arrow 404 such that an amount of the brine shrimp eggs (412) swept under the curtain of the boom (100) during a harvesting process is minimized. The flow of the water (428) in the first direction is parallel to a movement of the boom (100). For example, if the boom (100) is moving to the left, the flow of the water (428) in the first direction is to the right. If the boom (100) is moving to the right, the flow of the water (428) in the first direction is to the left.

Further, debris (410), such as live and dead adult/juvenile brine shrimp, feathers, broken off plant materials, or other material, is less buoyant than the brine shrimp eggs (412). As a result, the brine shrimp eggs (412) float closer to the surface (430) of the water (428) than the debris (410).

As mentioned above, the bottom section (102) along with the brine shrimp eggs (412) corralled against the mesh section (106) direct the water (428) to flow in a second direction as indicate by arrow 408 under the boom. Since the debris (410) is less buoyant that the brine shrimp eggs (412), the two may separate because the debris tends to follow the flow of the water (428) in the second direction. As a result, the debris (410) flow out of the boom (100) and the debris (410) is not collected in the boom (100).

In an example, the flow of the water (428) in the second direction is perpendicular to a movement of the boom (100). For example, as the boom (100) is moved to the left or the right, the flow of the water in the second direction is from the surface (430) of the water (428) towards the bottom of the floor (406) of the body of water.

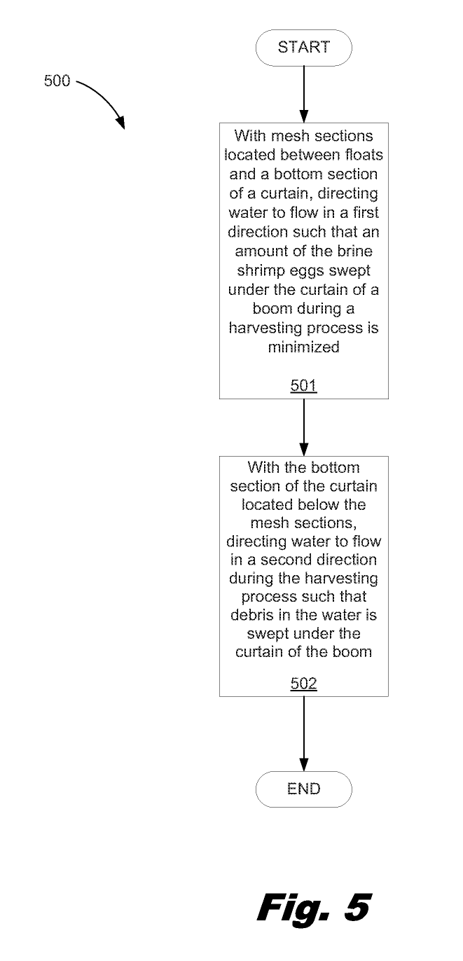

FIG. 5 is a flowchart of a method for harvesting brine shrimp eggs, according to one example of principles described herein. The method (500) includes with a number of mesh sections located between floats and a bottom section of a curtain, directing (501) water to flow in a first direction such that an amount of the brine shrimp eggs swept under the curtain of a boom during a harvesting process is minimized and with the bottom section of the curtain located below the mesh sections, directing (502) water to flow in a second direction during the harvesting process such that debris in the water is swept under the curtain of the boom.

As mentioned above, the method (500) includes with a number of mesh sections located between floats and a bottom section of a curtain, directing (501) water to flow in a first direction such that an amount of the brine shrimp eggs swept under the curtain of a boom during a harvesting process is minimized. In an example, the mesh sections include a number of openings that allow the water to flow through the curtain of the boom. Since the mesh sections are located between the floats and the bottom section, the mesh sections are thus located at or near the top of the curtain. As a result, during the harvesting process, the mesh sections are at or near the surface of the water to maximize the collection of the brine shrimp eggs. In some example, a mesh section is located in each section of the boom. In other examples, a mesh section is located on every other section of the boom.

As mentioned above, the method (500) includes with the bottom section of the curtain located below the mesh sections, directing (502) water to flow in a second direction during the harvesting process such that debris in the water is swept under the curtain of the boom. As mentioned above, the bottom section is a non-porous material that directs water and debris to flow out under the boom. Since the debris is less buoyant than the brine shrimp eggs, the debris tends to float under the brine shrimp eggs near the bottom section. Since the bottom section directs the water to flow in a second direction, the debris floating near the bottom section is swept under to curtain of the boom. As a result, the amount of debris collected by the boom is minimized.

The preceding description has been presented to illustrate and describe examples of the principles described. This description is not intended to be exhaustive or to limit these principles to any precise form disclosed. Many modifications and variations are possible in light of the above teaching.

What is claimed is:

1. A curtain of a boom for harvesting brine shrimp eggs, the curtain comprising:
a number of mesh sections for directing a flow of water in a first direction such that an amount of the brine shrimp eggs swept under the curtain of the boom during a harvesting process is minimized; and
a bottom section located below the mesh sections for directing a flow of water in a second direction during the harvesting process such that debris in the water is swept under the curtain of the boom.

2. The curtain of claim 1, wherein openings defined in the mesh sections are sized to allow the water, but not the brine shrimp eggs to flow through the mesh sections.

3. The curtain of claim 1, wherein the flow of the water in the first direction is parallel to a movement of the boom.

4. The curtain of claim 1, wherein the flow of the water in the second direction is perpendicular to a movement of the boom.

5. The curtain of claim 1, wherein the bottom section of the curtain is made of a nylon material, a vinyl material, or a plastic material.

6. The curtain of claim 1, wherein the bottom section is at least 5 inches in width.

7. The curtain of claim 1, wherein the bottom section of the curtain stiffens the curtain such that the curtain is maintained in a vertical position.

8. A boom for harvesting brine shrimp eggs, the boom comprising:
A number of sections, each of the sections comprising;
an upper section comprising:
a cable sleeve to accommodate a cable, the cable to direct the boom through water during a harvesting process; and
a float to provide buoyancy to a portion of the boom when the boom is submerged in water during the harvesting process; and
a curtain comprising:
a mesh section for directing a flow of the water in a first direction such that an amount of the brine shrimp eggs swept under the curtain of the boom during the harvesting process is minimized; and
a bottom section located below the mesh sections for directing a flow of the water in a second direction during the harvesting process such that debris in the water is swept under the curtain of the boom.

9. The boom of claim 8, further comprising stiffening rods located between each of the sections of the boom.

10. The boom of claim 9, wherein the stiffening rods maintain the upper section in parallel position to the curtain during the harvesting process.

11. The boom of claim 9, wherein the stiffening rods extend from a bottom of the cable sleeve to a top of the bottom section.

12. The boom of claim 8, wherein openings defined in the mesh section is sized to allow the water, but not the brine shrimp eggs to flow through the mesh section.

13. The boom of claim 8, wherein the bottom section accommodates a weight to retain the curtain of the boom below a surface of the water.

14. The boom of claim 8, wherein the bottom section of the curtain is made of a nylon material, a vinyl material, or a plastic material.

15. The boom of claim 8, wherein the bottom section is at least 5 inches in width.

16. The boom of claim 8, wherein the flow of the water in the first direction is parallel to a movement of the boom.

17. The boom of claim 8, wherein the flow of the water in the second direction is perpendicular to a movement of the boom.

18. A method for harvesting brine shrimp eggs, the method comprising:
with mesh sections located between floats and a bottom section of a curtain, directing water to flow in a first direction such that an amount of the brine shrimp eggs swept under the curtain of a boom during a harvesting process is minimized; and
with the bottom section of the curtain located below the mesh sections, directing water to flow in a second direction during the harvesting process such that debris in the water is swept under the curtain of the boom.

19. The method of claim 18, wherein openings defined in the mesh sections are sized to allow the water, but not the brine shrimp eggs to flow through the mesh sections in the first direction.

20. The method of claim 18, wherein the flow of the water in the second direction is perpendicular to a movement of the boom.
